(19) United States
(12) Patent Application Publication
(10) Pub. No.: US 2009/0295220 A1
(43) Pub. Date: Dec. 3, 2009

(54) Piston pump for a vehicle braking system

(76) Inventor: Helmut Gegalski, Muhlheim-Karlich (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/918,423

(22) PCT Filed: Apr. 12, 2006
(86) PCT No.: PCT/EP2006/003399

§ 371 Date: Jan. 6, 2009

(30) Foreign Application Priority Data
Apr. 14, 2005 (DE) 10 2005 017 283.0

(51) Int. Cl. B60T 8/40; F04B 1/04

(52) U.S. Cl. 303/116.4

(57) ABSTRACT

A piston pump for conveying a hydraulic fluid in a vehicle braking system is described. The piston pump comprises at least one chamber having an inlet and an outlet for the hydraulic fluid. A piston can be moved in a guided manner in the chamber in order to convey the hydraulic fluid along a conveying path from the inlet to the outlet, the piston co-operating with an activation mechanism. A fluidic control element is arranged in the conveying path between the inlet and the outlet. A sealing element is further received in the chamber in order to seal the chamber in a fluid-tight manner relative to the activation mechanism. The piston is constructed so as to be able to be moved relative to the sealing element.

### CROSS-REFERENCE TO RELATED APPLICATIONS

This application is a National Stage of International Application No. PCT/EP2006/003399 filed Apr. 12, 2006, and which claimed priority to German Patent Application No. 10 2005 017 283.0 filed Apr. 14, 2005, the disclosures of both are incorporated herein by reference.

### BACKGROUND

The invention relates to a piston pump. More precisely, the invention relates to a piston pump for conveying a hydraulic fluid in a vehicle braking system.

Modern hydraulic or electrohydraulic vehicle braking systems require reliable pressure generation mechanisms in order to be able to carry out safety-related functions, such as those of a hydraulic brake booster system, an anti-lock braking system (ABS), an adaptive cruise control system (ACC) or a traction control system (TCS). In these systems, a hydraulic pressure is generated, by means of a pressure generation unit—typically a piston pump—for controlling one or more wheel brakes.

Piston pumps for vehicle braking systems often comprise a plurality of pistons. The pistons are each arranged in a piston chamber and convey a hydraulic fluid from a chamber inlet to a chamber outlet. A fluidic control element, for example, in the form of a valve assembly, is arranged in most cases in a fluid conveying path between the inlet and the outlet.

Until a few years ago, each chamber was delimited by a sliding sleeve which was received in a fixed manner within a pump housing. The pistons moved within the sliding sleeves in a manner which minimised wear. A piston pump of this type is known, for example, from DE 32 36 536 A.

The use of sliding sleeves required the sliding sleeves with the pistons received therein first to be produced as sub-assemblies and subsequently to be placed in the pump housing. Not only the complex pump assembly, but also the number of components used was disadvantageous in this respect.

Based on the knowledge that the maximum operating time of pumps for the above-mentioned applications (over the lifetime of the pump) is often only a few tens of hours, and wear therefore not being highly significant, DE 93 19 462, and corresponding U.S. Pat. No. 5,823,639, both of which are incorporated by reference herein, proposes dispensing with the sliding sleeves which have the effect of reducing wear. Instead, the pump piston, a return spring which is provided therefor, and a valve assembly are placed with no sleeve as a sub-assembly which can be independently manipulated in a chamber which is formed in the pump housing. A sealing ring is fixed to the piston and prevents hydraulic fluid between the piston and the chamber wall from reaching the activation mechanism for the piston.

More recently, it has been shown that piston pumps can and ought to be used for an increasing number of functions within a vehicle braking system. For this reason, the anticipated pump operating times are increasing and in many cases exceed the few tens of hours for which the piston pump according to DE 93 19 462 is constructed. There is therefore currently an increasing demand for piston pumps to be required to be designed for operating times of 250 hours and more over their service life. The wear which is associated with such high operating times leads to further consideration again being given to the use of sliding sleeves. The disadvantages of sliding sleeves, which had been considered to have been overcome, are obviously taken into consideration again.

### SUMMARY

The present application describes various embodiments of a piston pump with little wear in which it is possible to dispense with sliding sleeves, if necessary.

In one embodiment, a piston pump is provided for conveying a hydraulic fluid in a vehicle braking system. The piston pump comprises at least one chamber having an inlet and an outlet for the hydraulic fluid, a piston which can be moved in a guided manner in the chamber in order to convey the hydraulic fluid along a conveying path from the inlet to the outlet, a fluidic control device which is arranged in the conveying path between the inlet and the outlet and a sealing element which is received in the chamber in order to close the chamber in a fluid-tight manner relative to an activation mechanism for the piston, the piston being able to be moved relative to the sealing element.

In this configuration of the piston pump, it is possible to dispense with sliding sleeves. Each chamber can therefore be directly delimited by a pump housing (for example, in the form of a solid metal block). Although a sleeveless configuration is preferred, it is possible to use sliding sleeves, if necessary, depending on the application and the anticipated operating time. The piston pump may comprise two, three or more chamber/piston units within a common housing block.

Each chamber can be subdivided into two, three or more chamber portions. The individual chamber portions may differ in terms of their diameter and/or function (for example, with regard to receiving the hydraulic fluid). For instance, the chamber may have a first chamber portion and a second chamber portion, the first chamber portion being open in the direction towards the activation mechanism and both the inlet and the outlet being arranged in the second chamber portion. The sealing element is advantageously provided in a region between the first chamber portion and the second chamber portion.

The piston may also be subdivided in an axial direction into two, three or more portions. The individual piston portions may be connected to each other, loosely abut each other or be mutually pretensioned. According to a first embodiment, the individual piston portions comprise the same material. According to a second embodiment, a first piston portion and a second piston portion are produced from different materials at least partially (for example, radially outwards and/or at end faces). For instance, the first portion may be produced from a wear-resistant, in particular metal, material and may be constructed so as to co-operate with the activation mechanism and/or the sealing element. The second piston portion may comprise a noise-damping material, such as a plastics material, and form or at least partially contain the fluidic control device. The first piston portion can be at least partially received in the first chamber portion and the second piston portion can be received in the second chamber portion.

In order to stabilise the sealing element within the chamber, at least one abutment face may be provided for the sealing element in the chamber. It is conceivable to fix the sealing element in position between two opposing abutment faces. A first abutment face in this instance can be provided by a step formed in the chamber. A second abutment face opposite the first abutment face can be provided by a retaining element which is introduced into the chamber.

The piston pump may be a radial piston pump or an axial piston pump, depending on the field of application. In the case of a radial piston pump, the at least one piston extends in a radial direction relative to a drive shaft of the activation mechanism. In the case of an axial piston pump, the at least one piston instead extends so as to be substantially parallel with the drive shaft.

Other advantages of the piston pump will become apparent to those skilled in the art from the following detailed description of the present embodiments, when read in light of the accompanying drawings.

### BRIEF DESCRIPTION OF THE DRAWINGS

FIG. 1 is a perspective view of an embodiment of a piston pump; and

FIG. 2 is a longitudinal section through a piston chamber of the piston pump according to FIG. 1.

### DETAILED DESCRIPTION

An embodiment of a pressure generation system in the form of a multi-piston pump for use in hydraulic or electrohydraulic vehicle braking systems is described below. The multi-piston pump set out supplies the hydraulic pressure required for controlling one or more wheel brakes and may be an integral component of a hydraulic brake booster system or an ABS, TCS, ACC or VSC (Vehicle Stability Control, also referred to as ESP) control device.

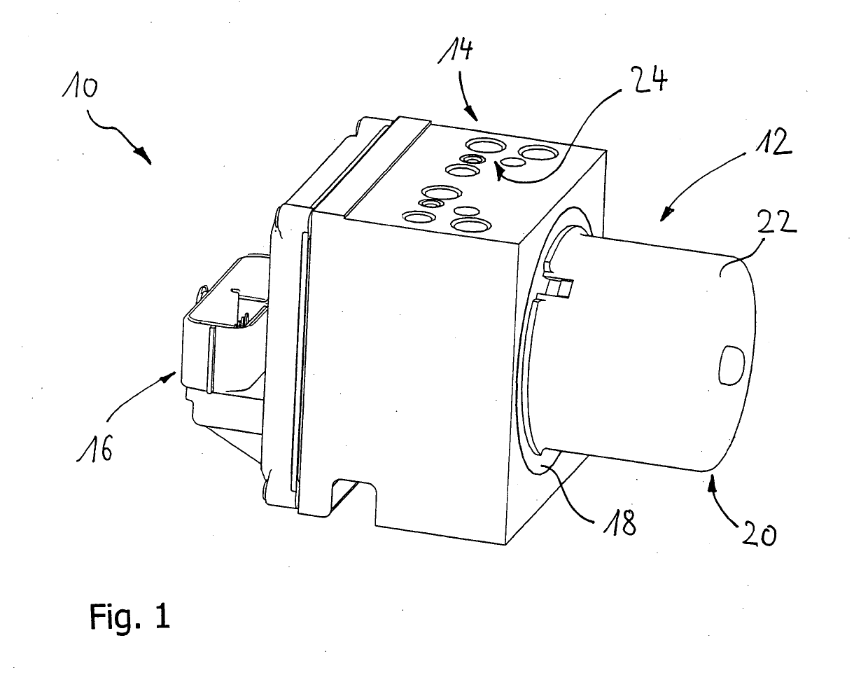

FIG. 1 is a perspective view of an embodiment of a radial multi-piston pump 10 for a vehicle braking system in the ready assembled state. The multi-piston pump 10 is suitable, for example, for implementing a VSC control device.

The multi-piston pump 10 according to FIG. 1 comprises a pump sub-assembly 12 which can be independently manipulated and which is partially received in a receiving housing 14 in the form of a solid aluminium block with fluid lines formed therein and with fluidic control devices arranged in the fluid lines. As a third superior component, the multi-valve pump 10 comprises a unit 16 which is fixed to the housing 14 for contacting the electrical components of the multi-piston pump 10.

The pump sub-assembly 12 which is partially inserted in the housing 14 has a circular block 18 which is only partially visible in FIG. 1 and which is of a wear-resistant material, such as aluminium (steel or grey cast iron would, however, also be suitable). From 2 to 6 pump chambers which are arranged in the form of a star (not illustrated) are typically formed inside the block 18.

As can be seen from FIG. 1, an activation unit 20 of the multi-piston pump 10 is fixed to the block 18. The activation unit 20 comprises a pot-shaped housing 22 and an electromotor which is received therein (not illustrated) and whose drive shaft extends substantially coaxially with the housing 22.

The receiving housing 14 for the pump sub-assembly 12 has, at the upper side thereof, a plurality of fluid connections 24. In the ready assembled state of the multi-piston pump 10, the multi-piston pump 10 is connected to a fluid source and to one or more hydraulic circuits by means of the fluid connections 24.

Contrary to the illustration in FIG. 1, the block 18 could also be constructed integrally with the housing 14. In this instance, the receiving chambers for the pistons would be formed in the housing 14.

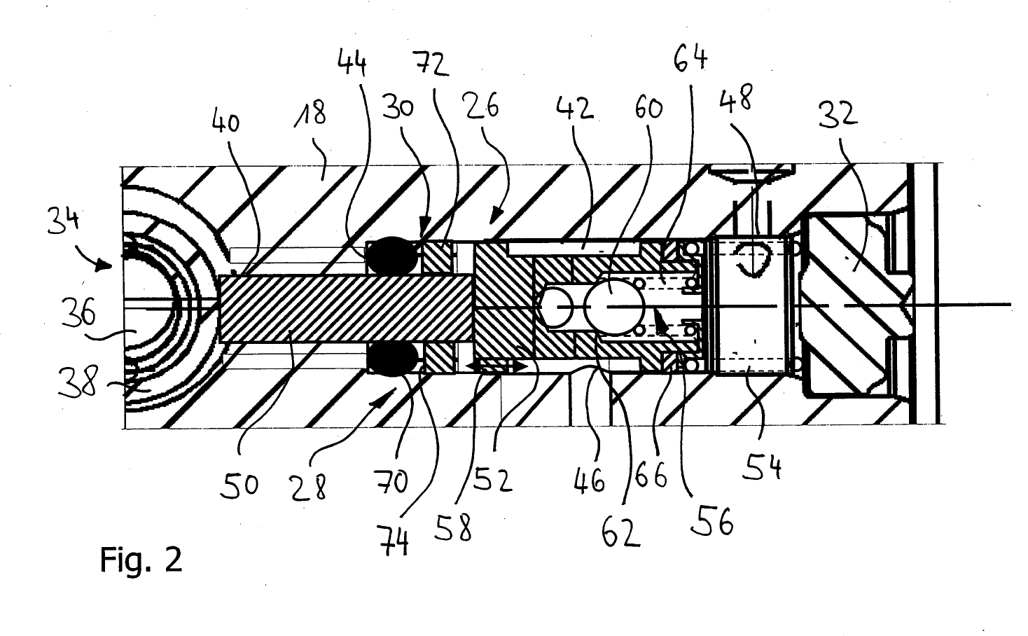

FIG. 2 is a longitudinal section of one of the chamber/piston units 26 formed in the block 18. The chamber/piston unit 26 illustrated in FIG. 2 comprises in the embodiment a chamber 28 which is divided in two and a piston 30 which comprises two portions.

The chamber 28 has a cylindrical shape with a stepped diameter. An end face of the chamber 28 adjacent to the radially outer edge of the block 18 is closed by means of a plug 32. However, the end face of the chamber 28 facing an activation mechanism 34 formed in the centre of the block 18 is open. The activation mechanism 34 comprises a motor shaft 36 and a cam 38 which is flanged onto the motor shaft 36. The operation of the activation mechanism 34 is explained in greater detail below.

The chamber 28 which is divided in two has a first chamber portion 40 which faces the activation mechanism 34 and a second chamber portion 42 which is closed by the plug 32. The first chamber portion 40 which is open towards the activation mechanism 34 has a smaller diameter than the second chamber portion 42. A step 44 is formed in the transition region between the first chamber portion 40 and the second chamber portion 42.

A fluid inlet 46 and a fluid outlet 48 are provided in the second chamber portion 42. The inlet 46 and the outlet 48 each open in a corresponding inlet or outlet channel in the block 18.

The piston 26 which is arranged inside the chamber 28 has a first piston portion 50 and a second piston portion 52. As can be seen in FIG. 2, the first piston portion 50 extends substantially within the first chamber portion 40 and can be moved in a guided manner therein.

The second piston portion 52 loosely abuts the first piston portion 50 but is pretensioned in the direction towards the first piston portion 50 by a return spring 54 which is supported on the plug 32. The first piston portion 50 abuts the cam 38 of the activation mechanism 34 with the end thereof facing the second piston portion 52 in a resiliently loaded manner (indirectly owing to the return spring 54). The first piston portion 50 comprises a hardened cylindrical steel body with ground end (and, if necessary, side) faces. The first piston portion 50 may, for example, be formed by a needle bearing roller body having a diameter of approximately 5.0 mm.

The second piston portion 52 can be moved in a guided manner in the second chamber portion 42, comprises plastics material or metal and receives therein a fluidic control device 56 in the form of a valve assembly. The second piston portion 52 and the valve assembly which is received therein comprise in known manner a fluid passage 58, a spherical valve element 60 having a diameter of approximately 3.5 mm, a spring 64 which pretensions the valve element 60 against a valve seat 62 and a high-pressure-resistant sealing element 66.

A sealing element 70 in the form of an O-ring is arranged in the second chamber portion 42 at the transition with respect to the first chamber portion 40. The sealing element 70 is fixed in position in an axial direction between the step 44 and a ring-like retaining element 72 which is introduced into the chamber. More precisely, the step 44 acts as a first abutment face for the sealing element 70 and the retaining element 72 provides, at the side thereof facing the sealing element 70, a second abutment face 74 for the sealing element 70.

The piston 30 and in particular the first piston portion 50 can be moved relative to the sealing element 70. That is to say, the sealing element 70 is substantially fixed in position relative to the chamber 28 in the present embodiment. The sealing element 70 is operationally arranged between a delimitation wall of the chamber 26 and the movable piston 30. In this manner, the sealing element 70 ensures a fluid-tight closure of the chamber 28 and in particular of the second chamber portion 42 relative to the activation mechanism 34.

When the activation mechanism 34 is activated, the cam 38 converts a rotation movement of the drive shaft 36 into a cyclical activation of the piston 28. Owing to the pretension produced by the spring element 54, the two piston portions 50 and 52 move in a synchronous manner. A complete rotation of the drive shaft 36 corresponds to a conveying stroke. In the context of a conveying stroke, pressurised hydraulic fluid is conveyed from the inlet 46 to the outlet 48. The fluidic control device 56 supports the fluid transport in the conveying direction and prevents a reflux of fluid. During the conveying movement of the piston 28, the first piston portion 50 slides along the sealing element 70. The sealing element 70 consequently prevents the hydraulic fluid from flowing out of the second chamber portion 42 through the first chamber portion 40 to the activation mechanism 34.

In contrast to conventional solutions in which the seal moves together with the piston along the chamber wall, in the present embodiment the hardened first piston portion 50 moves in the sealing element 70. In this manner, it is ensured that the aluminium/steel running pair in the region of the first chamber portion 40 and the first piston portion 50 is no longer interfered with by a receiving groove for a sealing element or the sealing element itself. It was at precisely these locations that occurrences of malfunction were previously often found and limited the operating times of the pump. With the arrangement according to the invention, it is therefore possible to achieve operating times of 250 hours or longer with no sliding sleeve.

In addition, the configuration according to the invention allows transverse forces in the high-pressure range to be reduced, in particular in the region of the second chamber portion 42. Furthermore, the invention allows conventional monolithic pistons to be divided into two separate piston portions which can each be produced from different functionally-optimised materials. The use of hardened and, if necessary, ground steel for the first piston portion 50 reduces the friction in the regions of interaction with the cam 38 and with the chamber wall. The use of plastics material for the second piston portion 52 allows a low-noise valve assembly 56 to be produced.

In accordance with the provisions of the patent statutes, the principle and mode of operation of the piston pump have been explained and illustrated in its various embodiments. However, it must be understood that this invention may be practiced otherwise than as specifically explained and illustrated without departing from its spirit or scope.

1. Piston pump for conveying a hydraulic fluid in a vehicle braking system, comprising:
at least one chamber having an inlet and an outlet for the hydraulic fluid;
a piston which can be moved in a guided manner in the chamber in order to convey the hydraulic fluid along a conveying path from the inlet to the outlet,
a valve which is arranged in the conveying path between the inlet and the outlet; and
a sealing element which is received in the chamber in order to close the chamber in a fluid-tight manner relative to an activation mechanism for the piston,
wherein the piston is subdivided in an axial direction into a first portion and a second portion which loosely abuts the first portion, the second portion abutting the first portion in a resiliently loaded manner.

2. Piston pump according to claim 1, wherein the chamber is directly delimited by a pump housing.

3. Piston pump according to claim 1, wherein the chamber has a first chamber portion and a second chamber portion, the first chamber portion being open in the direction towards the activation mechanism and both the inlet and the outlet being arranged in the second chamber portion and the sealing element being provided in a region between the first chamber portion and the second chamber portion.

4. Piston pump according to claim 1, wherein the first portion and the second portion are at least partially produced from different materials.

5. Piston pump according to claim 4, wherein the first portion is produced from a wear-resistant, in particular metal, material and the second portion contains a noise-damping material, in particular plastics material.

6. Piston pump according to claim 1, wherein the first portion of the piston co-operates with the activation mechanism and the sealing element.

7. Piston pump according to claim 1, wherein the second portion of the piston forms or at least partially contains the valve.

8. Piston pump according to claim 3, wherein the first portion of the piston is at least partially received in the first chamber portion and the second portion of the piston is received in the second chamber portion.

9. Piston pump according to claim 1, wherein at least one abutment face is provided for the sealing element in the chamber.

10. Piston pump according to claim 9, wherein a step is provided in the chamber and forms a first abutment face for the sealing element.

11. Piston pump according to claim 10, wherein a retaining element is introduced into the chamber and has a second abutment face opposite the first abutment face for the sealing element.

12. Piston pump according to claim 1, wherein the piston pump is a radial piston pump.

13. Piston pump according to claim 1, wherein the piston pump is an axial piston pump.

14. Piston pump according to claim 1, wherein the pump comprises at least two chamber/piston units in a common housing block.

15. Piston pump according to claim 1, wherein the piston can be moved relative to the sealing element.

16. Use of the piston pump according to claim 1 as an integral component of a vehicle braking system for conveying a hydraulic fluid.

17. Piston pump according to claim 1, wherein the first portion of the piston co-operates with the activation mechanism or the sealing element.
